(19) United States
(12) Patent Application Publication
(10) Pub. No.: US 2004/0005060 A1
(43) Pub. Date: Jan. 8, 2004

(54) Certification method using variable encryption key system based on encryption key of certification medium and inherent information of computer hardware, and certification medium for storing the same and indicating effective term and authorization thereof

(76) Inventors: Je Hyung Choi, Seoul (KR); Nam Hoon Cho, Kwangyuk-Si (KR); Nam il Choi, Seoul (KR)

Correspondence Address: Frank Chau, F Chau & Associates, Suite 501, 1900 Hempstead Turnpike, East Meadow, NY, 11554, US

(21) Appl. No.: 10/297,697

(22) PCT Filed: Jun. 9, 2001
(86) PCT No.: PCT/KR01/00987

(30) Foreign Application Priority Data
Jun. 10, 2000 (KR) 2000/32009

(51) Int. Cl. H04L 9/00

(52) U.S. Cl. 380/280; 713/156

(57) ABSTRACT

Disclosed is a method for certifying the identity of a user accessing the Internet and passing through a service gate over the Internet. In particular, the certification method uses a variable encryption key system based on encryption keys of a certification medium and inherent information of computer hardware. In the certification method, a certification medium is provided to the user, the certification medium is prepared by compilation of some pieces of encryption operation formula for certification into an execution file. When a user gains an access to the Internet for Internet use or certification, the remaining pieces of the certification formula are transmitted to the medium, thereby combining all the pieces of certification formula, forming a complete certification formula. Hardware information of the user computer is inputted thereinto, generating a unique value of encryption as certification information. The certification is completed when the certification is transmitted to the server.

### TECHNICAL FIELD

The present invention relates, in general, to a certification method used to certify a user when he/she accesses the Internet and passes through service gates thereon and, more particularly, to a certification method using a variable encryption key system based on encryption keys of a certification medium and inherent information of computer hardware, and a certification medium for storing the same and indicating an effective term and authorization thereof, wherein a user's identity can be certified without providing personal information of the user himself/herself, thereby preventing any damages from disclosure of personal information, and solving problems due to appropriation and/or losing of the user's ID and password.

### BACKGROUND ART

As well known to those skilled in the art, keeping pace with development of computer systems, there have also been great developments in the field of personal computers. Such developments have been very useful in processing information.

Likewise, keeping pace with development of personal computers, there has been a rapid progress in Internet-related technologies. Using these technologies, personal computers can be interconnected by a network to thereby allow information to be distributed therebetween.

The Internet provides a variety of functions necessary in our daily life, such as information retrieval and electronic commerce, etc.

However, in order to perform information retrieval and/or electronic commerce by means of the Internet, a user has to access a certain site providing such services (hereinafter, simply “service gate”). For such an access, the user's identity needs to be certified.

Such certification is important because it concerns transfer of money, and therefore, is of significance in reality.

The certification with respect to a user on the Internet to grant an access to service gates is usually made by allowing the user to log in and gain membership. The user himself/herself establishes an ID and a password within a limited text, and the user is requested to identify and manage his/her ID and password.

To use the ID and password, the user has to present his/her personal information at a service gate which he/she wishes to access and gain membership with the ID and password.

However, prior to gaining the membership, a number of users are concerned about the risk that their personal information may be disclosed in public, and are reluctant to enter their personal information, thereby blocking the users from actively using the service gates. As a consequence, in terms of contents providers (CP) who provide contents over the Internet, this becomes a major cause of economic loss for them.

Requests for specific personal information cause the users to reject use of the contents over the Internet; this situation is more serious in commercial service gates.

It is believed that Internet users dislike their personal information to be revealed, and at the same time wish to use Internet contents under the cover of false names.

To use the advantages and conveniences of the Internet and protect user's personal information, there has been developed and used a variety of encryption and decryption techniques and security systems. In the area of certifying a user's identity, a technique of certification has been proposed and used.

A known encryption algorithm with respect to a user certification can be briefly described.

Encryption algorithms are classified into symmetrical key encryption algorithms and public key encryption algorithms according to features of the keys. In symmetrical key encryption algorithms, keys for encryption and decryption are the same. In public key encryption algorithms, keys for encryption and decryption are different.

The symmetrical key encryption algorithms use the same keys for encryption and decryption, and therefore, there occur some problems in key management and certification as the users increase and a variety of encryption services are requested. Thus, a different algorithm is needed to solve these problems.

In 1976, W. Diffie and M. E. Hellman introduced a concept of public key encryption in “New Directions in Cryptography,” solving the above-mentioned problems.

Since then, a lot of public key encryption algorithms have been proposed; however, some problems arose in terms of safety and practicability. In 1978, the RSA (Rivest-Shamir-Adleman) public key encryption system was introduced, based on the difficulty in factorization in prime factors. The RSA system has been extensively used to date.

The Data Encryption Standard (DES) encryption system is a method of encoding and decoding messages, using the same symmetric keys, which only the transmitter and the receiver know.

However, the DES system is problematic in the sense that keys must be distributed in advance. That is, users in closed environments such as groups and companies can easily use the DES system; however, in open environments such as the Internet, there is a risk since users may have the same symmetric keys.

A number of symmetric keys (n*(n−1)/2) are necessary in order to allow many users to use the DES system. Creation and distribution of symmetric keys deteriorates the efficiency of the system. In addition, it is difficult to maintain and manage a number of symmetric keys.

RSA (initials of the inventors R. Rivest, A. Shamir and L. Adleman) public key encryption system uses two different keys, which have connection to each other, for encoding and decoding. That is, a transmitter encodes a message with a public key and transmits the encoded message, and a receiver decodes the message with a private key which only he/she knows.

All the users retain a pair of public key and private key of their own. The public key of a user is disclosed to transmitters who want to transmit messages to the user, but the private key is held in the user's own possession. The public key encryption system solves the problem of distributing keys in advance, and brings about a new concept of electronic signature.

The public key encryption system uses a unidirectional function, which indicates f(x), wherein if “x”, a unidirectional function, is given, it is easy to calculate y=f(x), however, if “y” is given, it is impossible to obtain a converse function of f(x), to obtain the value of “x”.

If “p” and “q”, each resulting from multiplication of two very large prime numbers, are also prime numbers having very large values, it is easy to calculate a composite number “n” (n=p*q) from “p” and “q”. However, it is very difficult or almost impossible to obtain “p” and “q” from “n”, and therefore, it serves to perform a goal of encryption in the public key encryption system using a unidirectional function.

Elliptical curves have been extensively studied in mathematics before about 150 years. Recently, they were significantly used in Andrew Wiles and Fermat's Last Theorem. 10 years ago, it was learned that Elliptic Curves Cryptosystem (ECC) are more efficient in their stability per bit than other public key encryption systems. Recently, ECC has been able to be performed at high speed.

The public key encryption system using elliptical curves has been actively studied since ECC based on discrete algebra in elliptical curve groups defined on finite fields were first proposed in 1985 by N. Koblitz and V. Miller. An elliptic curve method (ECM) has provided an efficient algorithm for analysis of factorization problems and criterions of prime numbers, which are the basis of the recent RSA encryption system.

The ECC is a system based on multiplying groups of finite fields, having the following merits.

A variety of elliptical curves capable of supplying the multiplying groups of finite fields can be utilized. In other words, it is easy to design a variety of encryption systems.

In the groups, there is no existence of subexponential time algorithms. That is, it is easy to design stable encryption system.

The ECC provides the same degree of stability as the other existing public schemes, with shorter length of keys (for example, the encryption systems with RSA 1024 bit keys and ECC 160 bit keys have the same degree of stability).

The addition operation in the elliptical curves includes an operation in finite fields, and thus, it is easy to express it with hardware and software. Furthermore, it has been known that the problem with respect to the discrete algebra in the group is much more difficult than the problem with respect to the discrete algebra in a finite field, K, of the same size.

As described above, there have been a variety of proposals and attempts to safely perform the user's authorization in terms of various types of encryption certification methods. However, since hacking or other relevant techniques to incapacitate encryption systems have also been developed in a steady manner, the conventional encryption certification methods and systems are still disadvantageous in that they are not likely to be used in a safe and secure manner.

The expected destruction of encryption systems causes personal information of users to be disclosed in public and also enables transactions to be distorted, posing a danger of causing enormous damages. Thus, this adversely affects the users so as to be reluctant to use, or to distrust electronic commerce via the Internet and circulation of information.

### DISCLOSURE OF THE INVENTION

Therefore, the present invention has been made in view of the above problems to solve the problems of the conventional encryption systems and to improve the disadvantages of the user certification methods controlled under the ID-password method.

Accordingly, it is an object of the present invention to provide a certification method using a variable encryption key system based on encryption keys of a certification medium and inherent information of computer hardware, and a certification medium for storing the same and indicating an effective term and authorization thereof, wherein certification information is created by combination of hardware information of a specific user computer and a certification formula, and therefore, a user is certified to log in the specific computer predetermined by the user, exclusive of the user's personal information, thereby completely guaranteeing security of the user's personal information.

It is another object of the present invention to provide a certification method using a variable encryption key system based on encryption keys of a certification medium and inherent information of computer hardware, and a certification medium for storing the same and indicating an effective term and authorization thereof, wherein a proper value creating a certification information is comprised of information hardware resources having a unique value, and an access to a service gate is only allowed through the specific computer having certified hardware resources, having first installed a certification medium and then accessed the service gate, and therefore, there is no need to manage the ID and password, and the certification medium is capable of regulating use thereof, in connection with reproduction thereof.

It is also another object of the present invention to provide a certification method using a variable encryption key system based on encryption keys of a certification medium and inherent information of computer hardware, and a certification medium for storing the same and indicating an effective term and authorization thereof, wherein a new certification information is created, corresponding to the existing certification information using an encryption formula varied in a stable manner, thereby preventing an appropriation of the password or an error in certification.

It is still another object of the present invention to provide a certification method using a variable encryption key system based on encryption keys of a certification medium and inherent information of computer hardware, and a certification medium for storing the same and indicating an effective term and authorization thereof, wherein since a user's personal information is not recorded in a server for a service gate, any damages resulting from disclosure of information kept in the server or disclosure by hacking can be fundamentally prevented.

It is still another object of the present invention to provide a certification method using a variable encryption key system based on encryption keys of a certification medium and inherent information of computer hardware, and a certification medium for storing the same and indicating an effective term and authorization thereof, wherein an accessible server can be registered through a certification method purchased in advance, and therefore, information use fee can be charged by a server providing services to a user, without resorting to settlement means such as a credit card.

It is still and still another object of the present invention to provide a certification method using a variable encryption key system based on encryption keys of a certification medium and inherent information of computer hardware, and a certification medium for storing the same and indicating an effective term and authorization thereof, wherein a user certification is available even if the user does not memorize the ID and password, and the user has no need to frequently change the password for security.

In accordance with the present invention, the above and other objects can be accomplished by the provision of a method for certifying a user on the Internet, employing variable encryption keys using encryption keys of a certification medium and proper information specific to a computer hardware, comprising the steps of: reading information of specific hardware inherently built in a user computer and providing a list with the information;

completing a certification formula by allowing a client computer to which a certification medium is installed to receive the remaining pieces of a certification formula from a server for a service gate and then combining them with the pieces of the formula recorded in the medium for operation of the certification information, the medium including a certification software; and substituting the combined certification formula for the specific hardware information and providing a complete certification information.

In the method, the provided certification information is transmitted to the server, along with a serial number of the certification medium so as to gain membership for user registration and receive an authorization for use.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically showing a concept of a certification method according to the present invention; FIG. 2 is a block diagram schematically showing a concept of the certification method processed by a client computer;

FIG. 3 is a block diagram schematically showing a concept of the certification method processed by a server computer;

FIG. 4 is a flowchart showing an installation method of a certification software to a user computer using a certification medium according to the present invention; and

FIG. 5 is a flowchart showing that the certification from the server through the medium of Internet is controlled, in the certification method using the certification medium according to the present invention.

### BEST MODE FOR CARRVING OUT THE INVENTION

Herein below, the technical idea of the present invention will be described in more detail.

For the sake of convenience, some terms referred to in describing the present invention have the following definition.

Certification formula: values transmitted from a server computer to a client computer, which are continuously changed at regular time intervals,

Piece of certification formula: a portion of certification formula recorded inside of the certification medium, which is combined with a formula transmitted from a server computer to form a complete certification formula,

Certification medium: a recording medium such as CD-ROM, recording programs therein, including combination keys for combining the pieces of certification formula necessary for certification and certification formula received from the server computer,

Serial number of certification medium: a series of numbers assigned when a certification medium is produced, to prove that the certification medium is regularly produced,

Service gate: a server responsible for actual certification, linking a server and a plurality of contents providers (CPs) to each other,

Certification software: logic for performing a certification procedure,

Certification information: values obtained by operating the certification formula, which are data values actually transmitted from a client server to a server computer, and

Hardware reference log: hardware list referred to when first installing a certifying software.

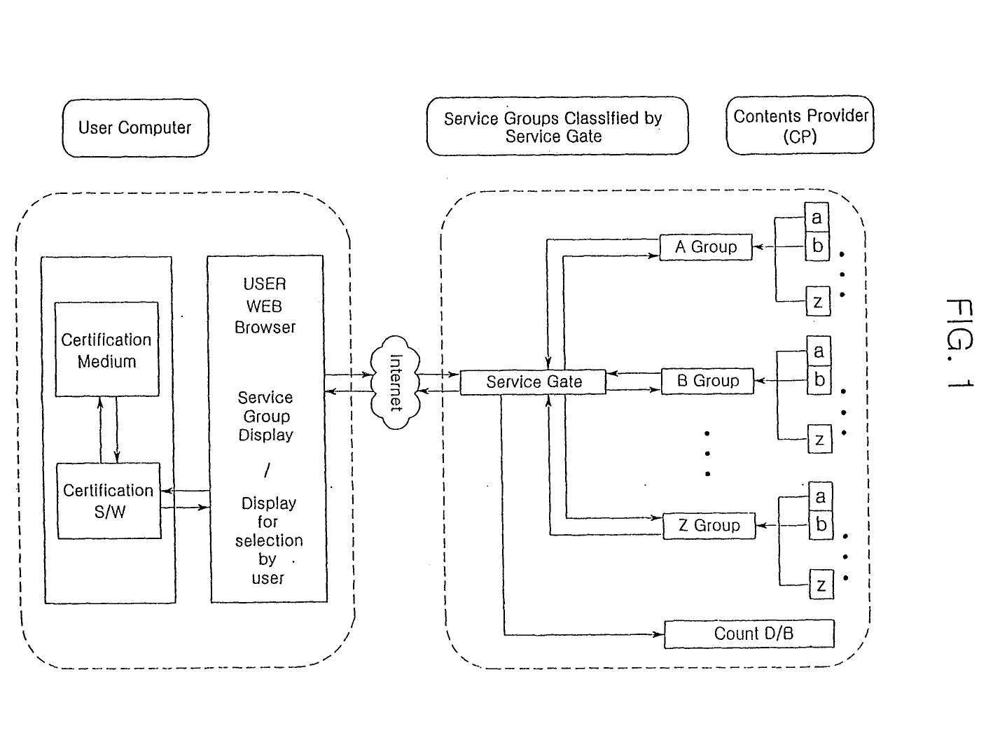

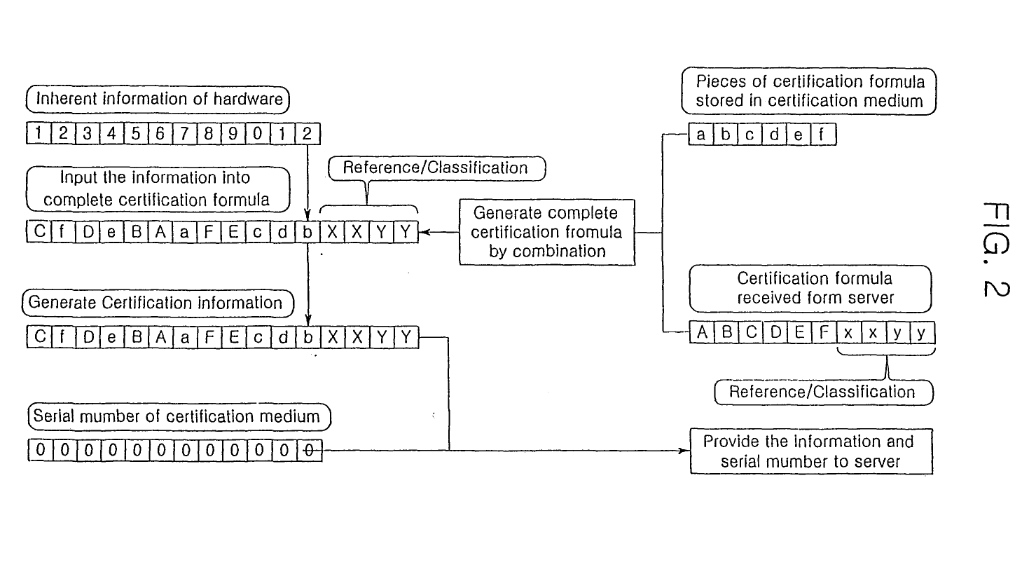

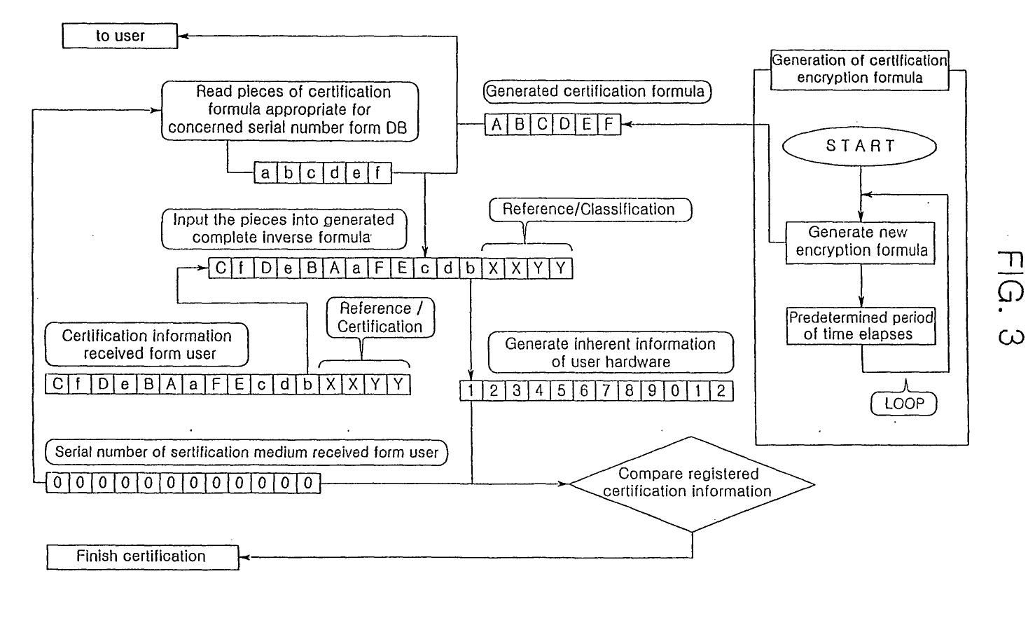

FIG. 1 is a block diagram schematically showing a concept of a certification method according to the present invention. FIG. 2 is a block diagram schematically showing a concept of the certification method processed by a client computer. FIG. 3 is a block diagram schematically showing a concept of the certification method processed by a server computer.

A user (client) first acquires a certification medium containing a certifying software therein, through purchase or any other method, in order to gain access to a contents provider (CP) through the Internet.

In the certification medium, pieces of certification formula are recorded as a part of the formula for certification.

The pieces of certification formula are included in an execution file and compiled. In such a case, two or more certification formula pieces are included in the execution file.

In the certification medium are recorded serial numbers as data, which are transmitted to a server when certifying the user.

If the certification medium is installed in a user computer and the computer is then connected to a server, the server transmits a certification formula or a remaining part of the certification encryption formula to a client. The remaining part of the certification encryption formula is combined with the certification formula pieces in the client computer, thereby forming a complete certification formula.

Proper hardware information having a unique value invariable within the user (client) computer is read, and the read information is substituted for the complete certification formula and operated. The operation produces certification information as a resulting value.

The certification information is transmitted to the server along with the serial number of the certification medium, and decoded in order to decide whether to certify the user.

The unique hardware information inside a client computer refers to information having uniquely different values with respect to respective computers, and the information exist in a unique manner, thereby being appropriate for maintaining security.

MAC address of a network card used in local area network (LAN) is preferably used as hardware information having a unique value.

MAC address is an address used by MAC hierarchy of OSI 7 hierarchies and data linking hierarchies, being comprised of a 48 bit hardware address of the network card and identical to an Ethernet address or Token-ring address. The network card (NIC) is an universally administered address (UAA) whose hardware address is assigned by its manufacturer, and all the network cards have respectively their own unique values.

Serial numbers of a hard disk and a RAM (Random Access Memory) can be used as hardware information having the unique values. By entering a production number used for maintenance thereof by the respective manufacturer, the serial numbers can become unique values.

A serial number of a CPU (Central Processing Unit) can be used as hardware information having the unique values. Currently, product groups which are capable of being brought out by browsing of programs are available in computers having a CPU more powerful than Pentium III.

A hard disk volume libel number can be used as hardware information having the unique values. It can be considered as being adoptable when it is difficult to obtain hardware information with a method supported by all the operating systems supported by Microsoft. It is a serial number assigned when the concerned hard disk is initialized, and it may be not unique. However, it is rare that users have the same numbers.

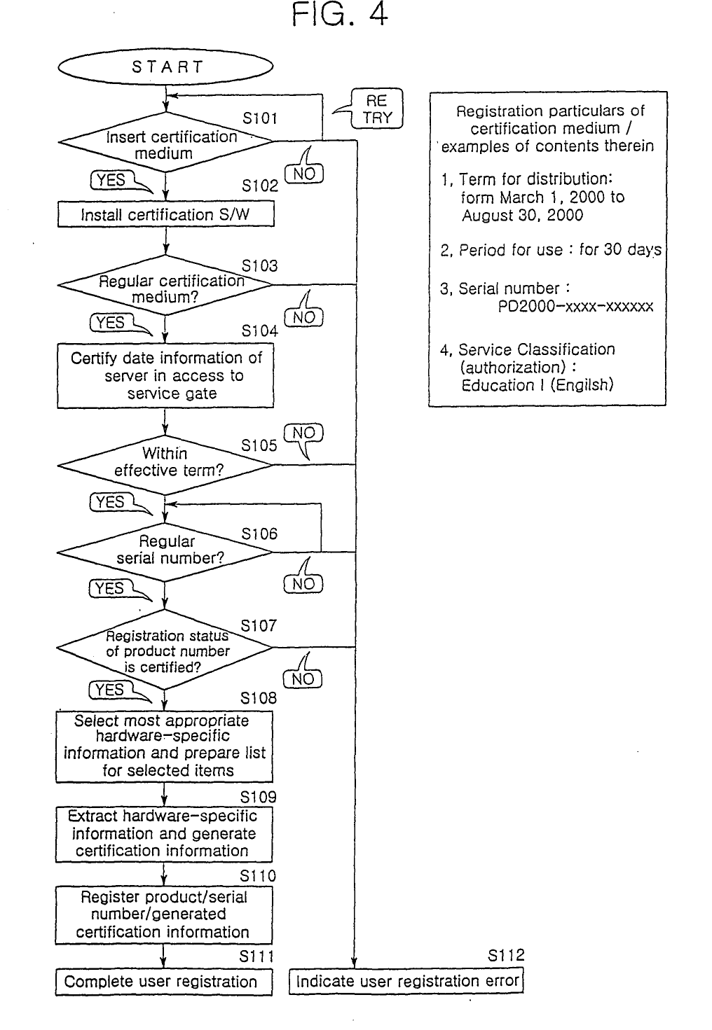

FIG. 4 is a flowchart showing an installation method of a user computer using a certification medium according to the present invention.

As described above, the certification medium is comprised of certification software performing a series of processes related to certification, and it records the terms of distribution and use of the medium, serial number thereof and service classification available for access therein.

The certification media can be manufactured in a various manner, respectively for education, entertainment, information retrieval, adult only, etc.

An URL (Uniform Resource Locator) of a contents provider (CP) according to classification is inputted into the manufactured certification media, so as to make it easy to be linked to each other.

In order to install a certification software to a user computer, a user purchases a certification medium such as a CD-ROM carrying the program and inserts it into its appropriate drive of his/her computer (S101).

If the computer ascertains an existence of the medium, a certification software recorded within the medium is called and automatically executed, to thereby complete the installation. If the installation is completed (S102), processes for certification can be performed. When a certification software has already been installed to a computer, the certification software is automatically executed.

The certification software ascertains whether the medium being inputted into a user computer is a regular certification medium (S103). The certification medium is under copy protection.

When the medium is ascertained as being regular, the medium is accessed to the Internet so as to be linked a service gate, and passes through a step of ascertaining date information from the server of the service gate (S104).

The inserted medium is ascertained from the date information from the server whether it is a medium within the term of distribution (S105). The term of distribution can be decided differently depending upon the service classification. It is desirable to establish the term of distribution usually within several months from the production date. The period of use is determined by calculating days (or time) while the user has actually used the service gate within the predetermined term of distribution.

When it is within the term of distribution, it is ascertained whether the serial number of product recorded in the certification medium is a regular product serial number (S106).

When the product serial number is regular, it is clarified that the certification medium is regular, through a step of ascertaining the status of registration of the product number (S107).

When it is repeatedly certified that the certification medium is regularly available for use, hardware information mostly appropriate for the user computer is chosen, to draft an item list for such a choice (S108).

As described above, the hardware information is one or combination of MAC addresses, serial numbers of hard disk or RAM, serial numbers of CPU and volume label of a hard disk.

The certification medium establishes a complete certification formula by combining pieces of certification formula recorded by itself and the remaining pieces of the certification formula from the server. The certification information is created by substituting it for hardware information selected with respect to the user computer (S109).

The created certification information are transmitted into a server along with the serial product number thereof and registered with the server (S110), thereby allowing installation of a certification software and user registration (S111) to be finished. It can be understood that the serial product number is an existing ID and the certification information combined with hardware information of the user computer is a password.

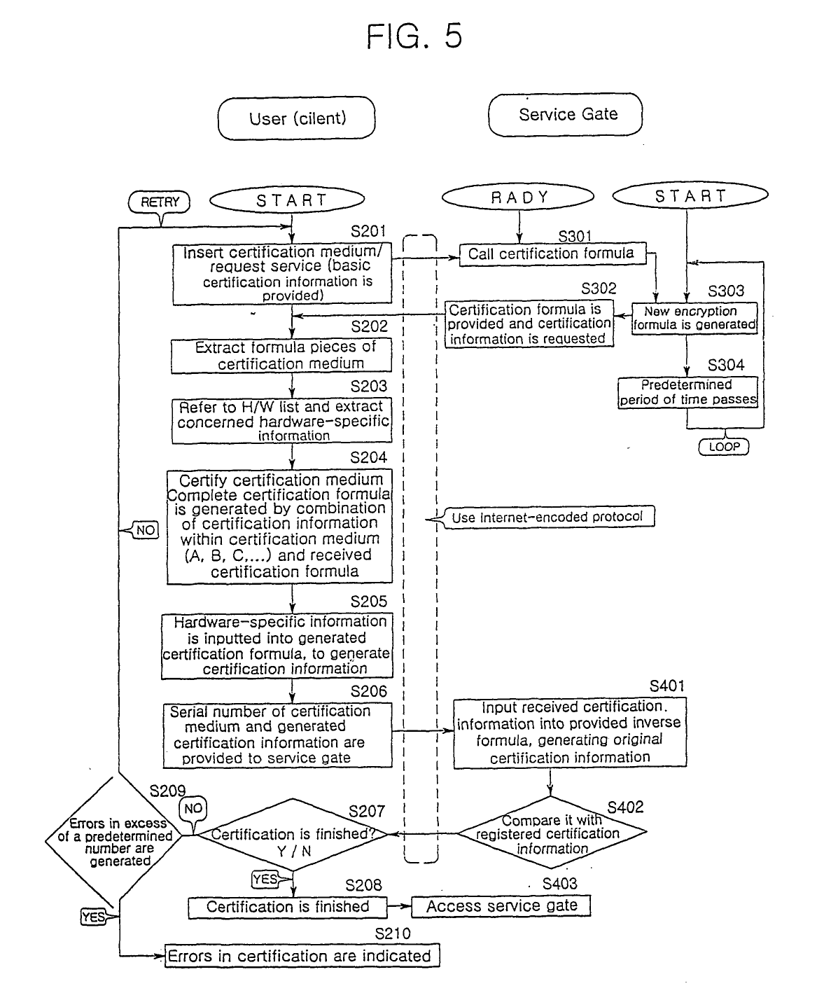

FIG. 5 is a flowchart showing that the certification from the server through the medium of Internet is controlled, in the certification method using the certification medium according to the present invention.

Where a user having gained membership attempts to access a specific contents provider (CP) through a service gate at the server, the following steps are performed.

First, a purchased certification medium is inserted into a user computer. In the step of requesting a service (S201), basic certification information is provided.

The server ascertains an existence of the client requesting the certification and calls a certification formula (S301), and the server transmits to a client (S302) combination keys designating a scheme of combining certification formula from a certification formula production server, certification information request and certification formula, and the certification formula production sever creates a new encryption formula (S303) whenever a predetermined time passes (S304).

The client computer extracts pieces of certification formula recorded in the certification medium (S202).

The certification formula is compiled in an execution file, thereby having security.

Information specific to concerned hardware is extracted from hardware list of the user computer (S203).

The certification formula transmitted from the server and pieces of certification formula read out from the certification medium are combined with each other to create a encryption certification formula by means of a combination formula included in the medium (S204). The combination method is determined according to combination keys transmitted along with the formula from the server.

The extracted information specific to the hardware is substituted for a certification formula completed by the combination described above and operated. The resulting values are created as certification information (S205).

A serial number of the certification medium and the created certification information are transmitted to a service gate at the server (S206), then the server substitutes the received certification information for a converse formula of the formula provided, creates a certification information by decoding (S401), compares it with the certification information registered at the installation thereof (S402), and transmits the certified contents to the client, and then the client ascertains the certification (S207 & S208) and allows the user to access a service gate as necessary (S403).

The access to the service gate is linked via a service gate at the server.

This is because chargeable information is recorded in the service gate, and the user fee is charged to and settled from the user, thereby making it advantageous to both the user and the CP.

Where the user fails to receive an authorization, a predetermined number of certifications are attempted in a repeated manner (S209). If the final certification is rejected, a certification error is indicated (S210) and the server terminates the connection.

The technical features of the present invention will be described in more detail with reference to several preferred embodiments.

Techniques for encryption described in “Background Art” may be adopted in performing transmission of encryption according to the present invention.

The certification method by means of a certification medium according to the present invention comprises three certification steps of inserting into a user computer a certification medium evidencing an authenticity of a user, ascertaining the serial number of the certification medium evidencing the genuineness of the medium purchased through legitimate procedures, and registering a certification by combination with information specific to hardware of the computer to which the medium is originally installed, in order to prevent losing of the certification medium or duplicate use. In these steps, the user's personal information is not required, thereby securing the anonymity and completely preventing the user's personal information from being disclosed.

The certification information generated with respect to hardware of the computer is not stored in the user computer; instead, it is combined with randomly produced certification formula transmitted from the server whenever it is required and operated, passing through repeated certification steps. The certification information is not fixed, and the certification is made with variable values.

Times when the certification is again made include the following cases:

when a user is registered at the time of first installing a certification software with a purchased certification medium;

when a user computer is first executed after access or certification software is upgraded with a new version, or necessary modules are automatically transmitted to a client computer;

when the user computer first logs in to be accessed to a service gate, to use the service; and

when a URL is changed from a current CP currently providing the services to a different CP. At this time, a new certification formula is in a combinative manner generated to operate the certification information.

For example, as structure of hardware information,

MAC address of a network card (NIC) is in the hexadecimal form, comprised of 12 digits (for example, 52.55.01.F4.A6.EF),

MAC address has fixable digits in the hexadecimal form, where serial numbers of a hard disk or a RAM is referred to (for example, 012abcd00123 . . . ),

MAC address has 23 digits in the hexadecimal form, where a serial number of a CPU is referred to (for example, 0000-0686-0000-1234-5678-9ABC).

MAC address has 8 digits in the hexadecimal form, where a volume label of a hard disk is referred to (for example, 1579-12AF).

As described above, it has been confirmed that hardware inherently installed within a computer has respectively a unique, different value for the purposes of management or classification by the manufacturer, and the unique value is utilized as major variables in certification.

One or more hardware information can be referenced.

Where the MAC address is referenced, if a value of 52.55.01.F4.A6.EF is read out and converted into ASCII code, it becomes 525501F4A6EF=535053534849705265546970. (The converted value can be converted into a value of −x in ASCII code, which is convenient in processing speed, calculation and useful in encoding the source.)

The contents of combinative formula include how to arrange which pieces of certification formula in which sequence, and how many digits a certification value used in calculation is calculated. They also declare which formula at the server will be performed, and which values will be used.

Pieces of certification formula within a certification medium are compiled in an execution file, and the certification formula is comprised of at least one piece.

For example, where there are pieces of certification formula named a, b, c, d, e and f,

a=Shift Left 8,

b=mod X

c=12367

d=127

e=XOR A

f=−40.

The certification formula received from the server is a formula varied at regular time interval at the server generating the certification formula, which generates a completely different value according to a combinative method of the formula. Where the certification formula is named A, B, C, D, E and F, if it is assumed that

A=227

B=\hat{ }A,

C=mod c,

D=(d\hat{ }A)mod A,

E=. . .

F=. . . , (these are merely described only for understanding; practicably each piece of the certification pieces has the values referenced as examples, and in addition, it has methods or classes capable of operating the concerned formula).

CC[x]=M[x](B)(C)(a) encoded value

CC[x]=((M[x]\hat{ }227 mod 12,367)*2\hat{ }8

Wherein, M is an ASCII code value of hardware information referenced, which is a source to be decoded, CC is an encoded value, and x indicates an arrangement.

If 58 is substituted for M[x],

CC[x]=((58\hat{ }227 mod 12,367)*2\hat{ }8=1,030,656.

In the case of x at Shift Left, x is not actually calculated as indicated in the formula, however, the resulting value is the same. Within a computer system, it is converted into a binary number for process, and all the numbers are moved to the left x times.

As understood from the above-described examples, whenever a certification is required, the server transmits its portion of a new certification formula to a client computer, and the client substitutes it for hardware information only in its possession, operating a complete certification formula and variably generating CC, a value of the certification value. Furthermore, the above-mentioned several encryption systems are applied to the password used in the certification as they are. Thus, even if the data is scanned, the contents thereof cannot be identified.

Industrial Applicability

As apparent from the above description, the present invention is effective in fundamentally preventing damages due to losing or appropriation of an ID and password in the existing certification method, and completely preventing duplicate use and appropriation since the certification information requests an authorization thereof by combining a portion of certification formula transmitted from the server in real time with the remaining formula within the user computer.

According to the present invention, a user does not determine a password, but information having an unique value among specific hardware information to be substituted to the certification formula is used, and so only one certification is authorized to one computer, thus being excellent in security of the password.

The specific hardware information is not stored with the user computer system. Whenever an authorization is requested, information of concerned hardware is called, using information designated with the most appropriate hardware according to the priorities among referable hardware lists, so as to generate a new authorization value, thus making it impossible to reproduce the password.

An authorization formula is completed by combination with some pieces of formula compiled in a certification medium and the remaining pieces of formula transmitted from the server, and therefore, even if the data is scanned in the course of transmission, the whole contents are not known, thereby making it secure.

According to the present invention, a user's personal information is not needed for certification in an Internet access and for settling any use fee, unlike conventional practice. Since the certification is made through a certification medium which has been purchased through a regular and lawful channel, the user can avoid any troubles in entering ID, password or serial number of the medium, etc. The certification system and method of this invention is thus excellent in comparison with the existing certification systems and methods.

1. A method for certifying a user on the Internet, employing variable encryption keys using encryption keys of a certification medium and proper information specific to a computer hardware, comprising the steps of:
reading information of specific hardware inherently built in a user computer and providing a list with the information;
completing a certification formula by allowing a client computer to which a certification medium is installed to receive the remaining pieces of a certification formula from a server for a service gate and then combining them with the pieces of the formula recorded in the medium for operation of the certification information, the medium including a certification software; and
substituting the combined certification formula for the specific hardware information and providing a complete certification information.

2. The method as set forth in claim 1, wherein the provided certification information is transmitted to the server, along with a serial number of the certification medium so as to gain membership for user registration and receive an authorization for use.

3. The method as set forth in claim 1, wherein the pieces of certification formula transmitted from the server for the service gate are transmitted to the client in real time when certification is requested, the transmitted formula pieces including key values for combination, thereby allowing operated certification information to vary.

4. The method as set forth in claim 1, wherein the hardware information is a proper value of a unit inherently installed in the computer, which is comprised of at least unique and invariable values.

5. The method as set forth in claim 4, wherein the hardware information is structured to provide a hardware reference log (list) when a certification software is installed, thereby calling necessary information and submitting it for an operation formula.

6. The method as set forth in claim 4, wherein the hardware information is comprised of at least one of MAC address of a NIC card, a serial number of hard disk, RAM or CPU, a volume label number of hard disk.

7. A certification medium for storing a program for certifying a user on the Internet, employing variable encryption keys using encryption keys of the certification medium and proper information specific to a computer hardware and indicating an effective term and authorization thereof, characterized in that:
some pieces of certification formula are complied into an execution file, for operating certification information;
hardware information specific to a computer to which the certification medium is installed is provided as a list, the hardware information being unique and differentiated from other computers;
a combinative formula is included, for a complete certification formula by combining said some pieces of certification formula with the remaining pieces of certification formula received from a server for a service gate; and
a series of sequences conducted to provide the complete certification formula is recorded, the certification formula being completed by inputting the specific hardware information into the completed combinative certification formula.
